(19) United States
(12) Patent Application Publication
(10) Pub. No.: US 2011/0126400 A1
(43) Pub. Date: Jun. 2, 2011

(54) Method of manufacturing lithium secondary battery

(75) Inventors: Su-Hwan Kim, Yongin-si (KR); Kwan-Seop Song, Yongin-si (KR); Byoung-Kuk Kim, Yongin-si (KR); Soon-Gon Yoon, Yongin-si (KR)

(73) Assignee: Samsung SDI Co., Ltd., Yongin-si (KR)

(21) Appl. No.: 12/805,860

(22) Filed: Aug. 20, 2010

(30) Foreign Application Priority Data
Nov. 27, 2009 (KR) 10-2009-0115924

(51) Int. Cl. H01M 2/36

(52) U.S. Cl. 29/623.1

(57) ABSTRACT

A method of manufacturing a lithium secondary battery, the method includes the operations of injecting a lithium salt; arranging an electrode assembly comprising a positive electrode, a separator, and a negative electrode; and injecting a solvent excluding the lithium salt.

### CLAIM OF PRIORITY

This application makes reference to, incorporates the same herein, and claims all benefits accruing under 35 U.S.C. §119 from an application earlier filed in the Korean Intellectual Property Office on 27 Nov. 2009 and there duly assigned Serial No. 10-2009-0115924.

### BACKGROUND OF THE INVENTION

1. Field of the Invention

One or more embodiments of the present invention relate to a method of manufacturing a lithium secondary battery, and more particularly, to a method of injecting an electrolyte solution into a lithium secondary battery.

2. Description of the Related Art

A secondary battery is a rechargeable battery, and is widely used in portable electronic devices including cellular phones, notebook computers, camcorders, and the like.

### SUMMARY OF THE INVENTION

It is therefore one aspect for the present invention to provide an improved method of manufacturing a lithium secondary battery, whereby a speed of impregnating an electrolyte solution into a separator of the lithium secondary battery is increased.

Additional aspects will be set forth in part in the description which follows and, in part, will be apparent from the description, or may be learned by practice of the presented embodiments.

In accordance with one or more embodiments of the present invention, a method of manufacturing a lithium secondary battery includes the operations of injecting a lithium salt; arranging an electrode assembly comprising a positive electrode, a separator, and a negative electrode; and injecting a solvent excluding the lithium salt.

The method may be performed in an order of the operations of arranging the electrode assembly; injecting the lithium salt; and injecting the solvent excluding the lithium salt.

The method may be performed in an order of the operations of arranging the electrode assembly; injecting the organic solvent excluding the lithium salt; and injecting the lithium salt.

The method may further include the operations of performing a vacuuming operation; and performing a pressurizing operation.

The method may be performed in an order of the operations of arranging the electrode assembly; injecting the solvent excluding the lithium salt; performing the vacuuming operation; performing the pressurizing operation; and injecting the lithium salt.

The lithium salt may be in a solid state. However, the lithium salt may be in a liquid state.

The lithium salt may have a molar concentration in a range of about 0.8 mol/L to about 1.7 mol/L when the lithium salt is mixed with the solvent.

The lithium salt may be at least one selected from the group consisting of LiPF₆, LiBF₄, LiClO₄, Li(CF₃SO₂)₂, LiCF₃SO₃, LiSbF₆ and LiAsF₆.

The solvent may be a mixture of cyclic carbonate selected from the group consisting of polyethylene carbonate, ethylene carbonate, and propylene carbonate, and chain carbonate selected from the group consisting of dimethyl carbonate and diethyl carbonate.

The electrode assembly may be wound and may have a center pin in a center therein, and the injecting the lithium salt may include charging the lithium salt in the center pin.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a perspective view of an angled lithium secondary battery;

FIG. 2 is a cross-sectional view of the angled lithium secondary battery of FIG. 1, taken along a line II-II;

FIG. 3A is a diagram for showing an exploded impregnated separator after an electrolyte solution is injected;

FIG. 3B is a diagram for showing an exploded impregnated separator after an organic solvent excluding a lithium salt is injected;

FIG. 4 is a flowchart of a method of manufacturing a lithium secondary battery in accordance with an embodiment of the present invention;

FIG. 5A is a cross-sectional view for describing a stage 5401 in which a lithium salt is injected, in accordance with the method of FIG. 4;

FIG. 5B is a cross-sectional view for describing a stage 5402 in which an electrode assembly and other elements are arranged, in accordance with the method of FIG. 4;

FIG. 5C is a cross-sectional view for describing a stage 5403 in which an organic solvent excluding the lithium salt is injected, in accordance with the method of FIG. 4;

FIG. 5D is a cross-sectional view for describing a stage 5404 in which a case is pressurized in accordance with the method of FIG. 4;

FIG. 6 is a flowchart of a method of manufacturing a lithium secondary battery in accordance with another embodiment of the present invention;

FIG. 7 is a flowchart of a method of manufacturing a lithium secondary battery in accordance with still another embodiment of the present invention; and

FIG. 8 is a flowchart of a method of manufacturing a lithium secondary battery in accordance with yet another embodiment of the present invention.

### DETAILED DESCRIPTION OF THE INVENTION

Reference will now be made in detail to embodiments, examples of which are illustrated in the accompanying drawings.

The secondary battery has a structure in which an electrode assembly in the shape of a jelly roll formed by rolling a positive electrode, a negative electrode, and a separator disposed therebetween is inserted into a case via an opening of the case, and then a cap plate covers the opening of the case.

An electrical current collection unit is arranged in an end of the electrode assembly, and is electrically connected to an electrode terminal arranged in the cap plate. Therefore, by connecting an external terminal to the electrode terminal of the cap plate, the electrical current that is generated in the electrode assembly is supplied to the external terminal via a cap assembly and terminals of the current collection unit. Here, the current collection unit is welded to the end of the electrode assembly, and then simultaneously functions to form a path of the current and to support the shape of the jelly roll.

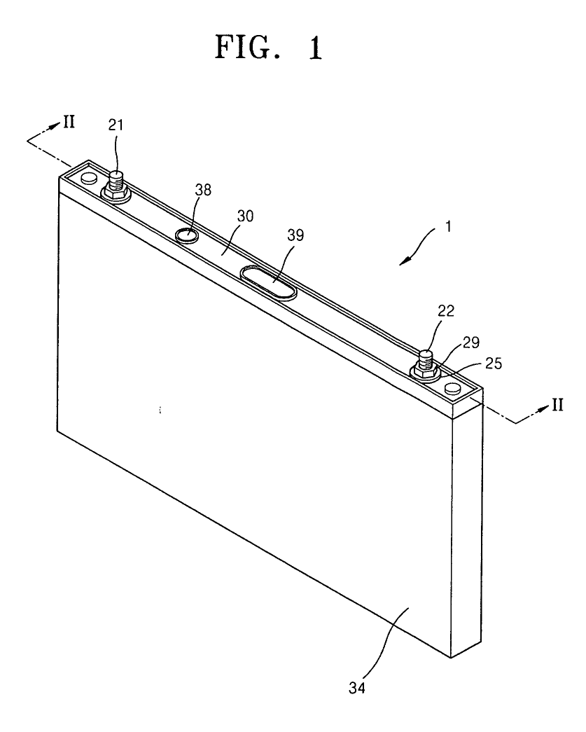

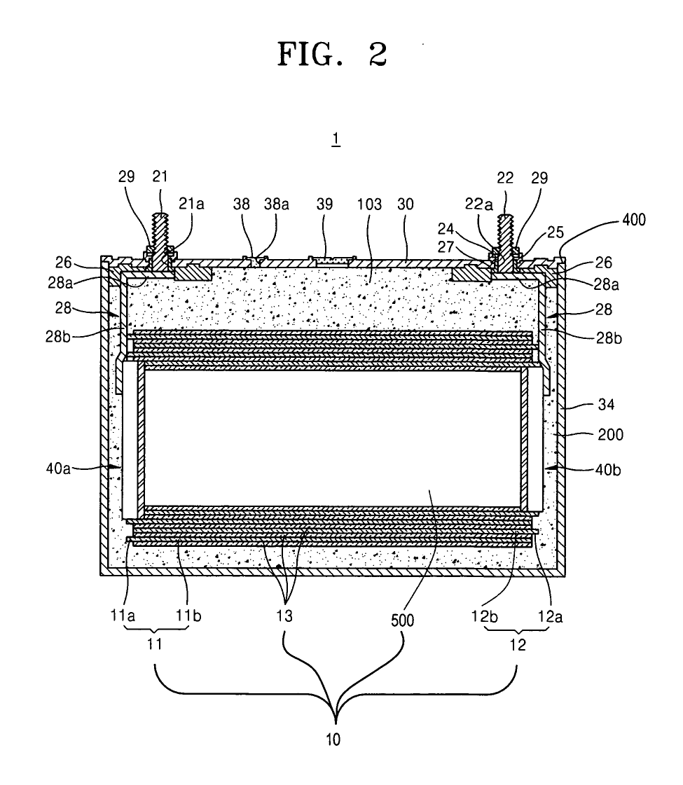

With reference to FIGS. 1 and 2, a structure of a secondary battery 1 will now be described, and then a method of impregnating an electrolyte solution 103 into an electrode assembly 10 of the secondary battery 1 will be described. FIG. 1 is a perspective view of the secondary battery 1. FIG. 2 is a cross-sectional view of the secondary battery 1 of FIG. 1, taken along a line II-II.

Referring to FIGS. 1 and 2, the secondary battery 1 includes the electrode assembly 10, electrode terminals 21 and 22, and a case 34. Here, the case 34 includes the electrode assembly 10 that may be electrically connected to the outside via the electrode terminals 21 and 22.

The electrode assembly 10 includes a positive electrode 11, a negative electrode 12, and a separator 13. Here, the positive electrode 11 and the negative electrode 12 may be wound by interposing the separator 13 that is an insulator therebetween, and thus may form the electrode assembly 10. The electrode assembly 10 may be formed in such a manner that a center pin 500 may be disposed in an inner side and then the positive electrode 11, the negative electrode 12, and the separator 13 may be wound with respect to the center pin 500, or in such a manner that the positive electrode 11, the negative electrode 12, and the separator 13 may be sequentially stacked.

The positive electrode 11 and the negative electrode 12 may include uncoated portions 11a and 12a, and coated portions 11b and 12b, respectively. The uncoated portions 11a and 12a may indicate portions of a current collector formed of a thin metal foil, which are not coated with an active material. The coated portions 11b and 12b may indicate portions of the current collector formed of the thin metal foil, which are coated with the active material.

The positive electrode uncoated portion 11a is formed on one side end of the positive electrode 11 in a longitudinal direction of the positive electrode 11. The negative electrode uncoated portion 12a is formed on another side end of the negative electrode 12 in a longitudinal direction of the negative electrode 12. Meanwhile, the electrode assembly 10 may be formed in such a manner that the positive electrode 11, the negative electrode 12, and the separator 13 are cylindrically rolled and then pressurized. Here, the electrode assembly 10 may be pressurized to be plate-shaped.

A positive electrode current collector 40a may be welded to the positive electrode uncoated portion 11a of the electrode assembly 10. The positive electrode current collector 40a may be electrically connected to the positive electrode terminal 21 via a lead member 28. Accordingly, the positive electrode terminal 21 may be connected to the positive electrode 11 of the electrode assembly 10 via the lead member 28 and the positive electrode current collector 40a.

A negative electrode current collector 40b may be electrically connected to the negative electrode terminal 22 via the lead member 28. Accordingly, the negative electrode terminal 22 may be electrically connected to the negative electrode 12 of the electrode assembly 10 via the lead member 28 and the negative electrode current collector 40b. Electrical insulation members 26 may be arranged to act as an electrical insulator between the lead member 28 and a cap plate 30. The lead member 28 may include a current collecting lead unit 28b that is attached to a current collecting unit 40, and a terminal lead unit 28a that is attached to the electrode terminals 21 and 22. The electrode terminals 21 and 22 may include the positive electrode terminal 21 and the negative electrode terminal 22. The positive electrode terminal 21 and the negative electrode terminal 22 may be electrically connected to the positive electrode 11 and the negative electrode 12 of the electrode assembly 10, respectively, and thus may be exposed to the outside of the case 34.

Terminal holes 21a and 22a may be formed in the cap plate 30 through the cap plate 30. The terminal holes 21a and 22a may include a positive electrode terminal hole 21a and a negative electrode terminal hole 22a. The positive electrode terminal 21 may protrude to the outside through the positive electrode terminal hole 21a. The negative electrode terminal 22 may protrude to the outside through the negative electrode terminal hole 22a. An upper gasket 25 and a lower gasket 27 are disposed between the cap plate 30 and the electrode terminals 21 and 22 so as to perform an insulating function between the cap plate 30 and the electrode terminals 21 and 22. The lower gasket 27 is inserted into the terminal holes 21a and 22a so as to be installed at a lower portion of the cap plate 30. The upper gasket 25 is installed at an upper portion of the cap plate 30. A washer 24 for buffering a clamping force is installed on the upper gasket 25. Screw threads may be formed on the positive electrode terminal 21 and the negative electrode terminal 22, respectively, so as to be coupled to a nut 29. The nut 29 supports the electrode terminals 21 and 22 from above. An insulating element 26 is formed between the lead element 28 and a cap plate 30 in order to insulate therebetween. The lead element 28 includes current collecting lead elements 28b attached to the current collectors 40a and 40b, and terminal lead elements 28a attached to the electrode terminals 21 and 22.

The case 34 may have the cap plate 30 formed on one side of the case 34. The case 34 may have an angular can-shape one side of which is open, and the open side of the case 34 may be sealed by the cap plate 30. The cap plate 30 may cover the case 34, while allowing the electrode terminals 21 and 22 to protrude to the exterior. A gap between the case 34 and the cap plate 30 may be laser-welded at a welded portion 400 so that the case 34 including the electrode assembly 10, and thus the electrolyte solution 103 may be sealed within the case 34. The cap plate 30 may be formed of a thin plate.

Also, a vent member 39 having a groove formed therein may be mounted in the cap plate 30 so as to break open at a set internal pressure. Here, a configuration of the secondary battery 1 is not limited to a configuration illustrated in FIG. 2, and thus may vary. For example, the secondary battery 1 may be a cylindrical-shape secondary battery, a polymer secondary battery or an angular-shape secondary battery. Here, each of the cylindrical-shape secondary battery, the polymer secondary battery, and the angular-shape secondary battery may be formed by being rolled with respect to a center pin, or may be formed in a stacking manner. Here, an electrolyte solution injection hole 38a via which the electrolyte solution 103 is injected may be formed in the cap plate 30. A sealing cap 38 may be inserted into the electrolyte solution injection hole 38a in order to seal the electrolyte solution injection hole 38a.

Hereinafter, a method of injecting the electrolyte solution 103 into the case 34 of the secondary battery 1, and impregnating the electrolyte solution 103 into the electrode assembly 10 will be described.

The reason why a process of impregnating the electrolyte solution 103 into the separator 13 of the electrode assembly 10 is important is that a non-impregnated area rapidly deteriorates while the secondary battery 1 is charged and discharged, such that a capacity of the secondary battery 1 is decreased, and a lifespan of the secondary battery 1 may be shortened.

Also, a chemical characteristic of the secondary battery 1 in which the electrolyte solution 103 is sufficiently impregnated into the separator 13 is excellent compared to a battery in which the electrolyte solution 103 is not sufficiently impregnated into the separator 13. Thus, a procedure of impregnating the electrolyte solution 103 into the separator 13 of the electrode assembly 10 is important.

This impregnation may be processed while being exposed to the atmospheric air. However, in order to increase an impregnating speed, a pressurizing process or a vacuuming process may be repeatedly performed. Such an impregnation procedure generally takes a relatively long time. Also, when the capacity of a battery increases, a time taken to perform impregnation also increases. In addition, in order to increase production, the number of pieces of equipment or a scale of a total system has to be increased, thus causing investment costs and operating costs to also be increased.

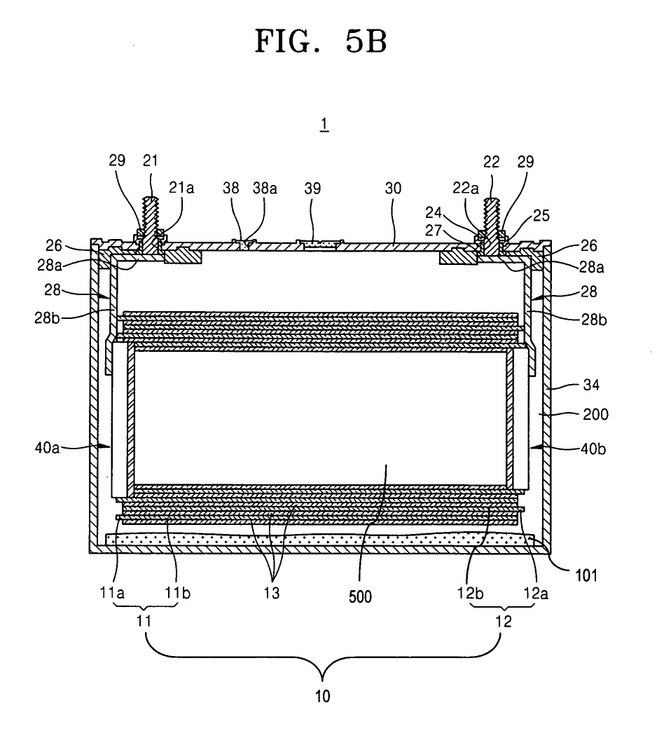

At this time, as shown in FIG. 5A through 5D, when a solvent 102 excluding a lithium salt 101 is impregnated into the separator 13, the separator 13 is impregnated at an impregnation speed faster than an impregnation speed of the electrolyte solution 103 including the lithium salt 101. Here, the electrolyte solution 103 may be obtained by dissolving the lithium salt 101 into the solvent 102.

Hereinafter, reference numeral 102 indicates an organic solvent 102 that does not include the lithium salt 101. In this manner, in order to increase the impregnation speed of the electrolyte solution 103 by using the fast impregnation speed of the organic solvent 102 excluding the lithium salt 101, an electrolyte solution injection process may be divided into a lithium salt injection process and an organic solvent injection process.

Here, the lithium salt 101 may be in a solid state or a liquid state. The lithium salt 101 may be at least one selected from the group consisting of LiPF₆, LiBF₄, LiClO₄, Li(CF₃SO₂)₂, LiCF₃SO₃, LiSbF₆ and LiAsF₆.

Also, the organic solvent 102 may be a mixture of cyclic carbonate selected from the group consisting of polyethylene carbonate, ethylene carbonate, and propylene carbonate, and chain carbonate selected from the group consisting of dimethyl carbonate and diethyl carbonate. Here, the organic solvent 102 may be left in the secondary battery 1 after assembling the secondary battery 1 and thus may be electro-chemically exchangeable with the electrolyte solution 103. The description of the organic solvent 102 not including the lithium salt 101 however may not be strictly construed. That is, as concentration of the lithium salt 101 of the organic solvent 102 is lowered, a speed of the organic solvent 102 being impregnated into the separator 13 is increased. Thus, in the case where the organic solvent 102 includes a small quantity of the lithium salt 101, concentration of the lithium salt 101 is low so that the same effect of fast impregnation may occur. Thus, the organic solvent 102 including the small quantity of the lithium salt 101 is also included in the protection scope of the present invention.

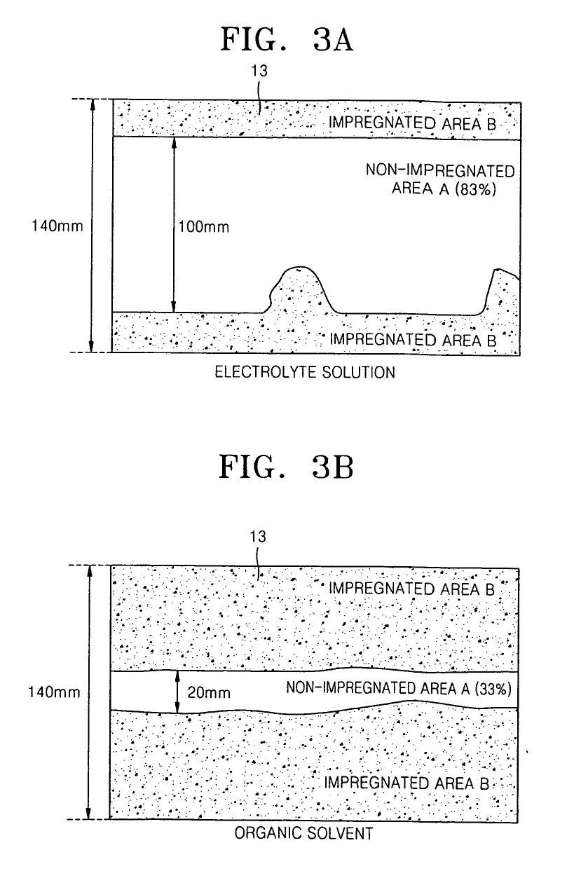

By referring to FIGS. 3A and 3B, a first case of the electrolyte solution 103 being impregnated into the separator 13 and a second case of the organic solvent 102 being impregnated into the separator 13 excluding the lithium salt 101 are compared and described. FIG. 3A is a diagram for describing a result of a first experiment for showing an impregnation degree of the exploded separator 13 after the electrolyte solution 103 is injected therein. FIG. 3B is a diagram for describing a result of a second experiment for showing an impregnation degree of the separator 13 after the organic solvent 102 excluding the lithium salt 101 is injected therein.

The first experiment of FIG. 3A will now be described. First, while the case 34 constantly remains in a vacuum state in which a vacuum degree of about 0.1 Torr is maintained, a lithium salt (LiPF₆) is dissolved into organic solvents of ethylene carbonate and dimethyl carbonate and thus, the electrolyte solution 103 having a concentration of about 1.3 mol/L is injected into the case 34. Here, about 60 seconds are taken to inject the electrolyte solution 103, and after the injection is performed, the case 34 is immediately opened. About 7 minutes are taken to open the case 34. FIG. 3A is a diagram of the separator 13 spread out after the case 34 is opened after the first experiment. In FIG. 3A, a non-impregnated area A and an impregnated area B are illustrated after being divided. In the first experiment, the non-impregnated area A of the electrolyte solution 103 occupies about 83% of the separator 13. In other words, the electrolyte solution 103 impregnates the separator 13 by about 17%.

The second experiment of FIG. 3B is conducted in a similar condition to the first experiment. That is, the case 34 constantly remains in the vacuum state in which the vacuum degree of about 0.1 Torr is maintained, and the organic solvent 102 having the same volume as the volume of the electrolyte solution 103, which is used in the first experiment of FIG. 3A, is used. Here, as the organic solvent 102, ethylene carbonate and dimethyl carbonate are used. In the second experiment, about 60 seconds are also taken to inject the organic solvent 102, and after the injection is performed, the case 34 is immediately opened. About 7 minutes are taken to open the case 34. FIG. 3B is a diagram of the separator 13 spread out after the case 34 is opened after the second experiment. In the second experiment, the non-impregnated area A of the organic solvent 102 occupies about 33% of the separator 13. In other words, the organic solvent 102 impregnates the separator 13 by about 67%.

In the first and second impregnation experiments wherein the same pressure and the same volume of solvent are used, the electrolyte solution 103 impregnates the separator 13 by about 17% of the separator 13, and the organic solvent 102 impregnates the separator 13 by about 67% of the separator 13. Therefore, it is clear that the impregnation speed of the organic solvent 102 excluding the lithium salt 101 with respect to the separator 13 is significantly faster compared to the impregnation speed of the electrolyte solution 103.

In this manner, since the impregnation speed of a case in which the organic solvent 102 is impregnated into the separator 13 is faster than the impregnation speed of a case in which the electrolyte solution 103 is directly impregnated into the separator 13, an impregnation process speed may be increased. Here, the lithium salt 101 in the solid or liquid state is rapidly dissolved into the organic solvent 102 so that the electrolyte solution 103 may be obtained in such a manner that the organic solvent 102 may be first impregnated into the separator 13 and then the lithium salt 101 may be dissolved into the organic solvent 102. Here, the lithium salt 101 and the organic solvent 102 may be impregnated into the separator 13 by using various methods.

In other words, the solvent 102 and the lithium salt 101 are separately injected into the separator contained within the case 34. The resulted solution of the mixture of the solvent 102 and lithium salt 101 is the electrolyte solution 103. The separate injections of the solvent 102 and the lithium salt 101 advantageously increase the impregnation speed of the electrolyte solution 103, because the impregnation process speed of the solvent 102 alone is significantly faster compared to that of the electrolyte solution 103.

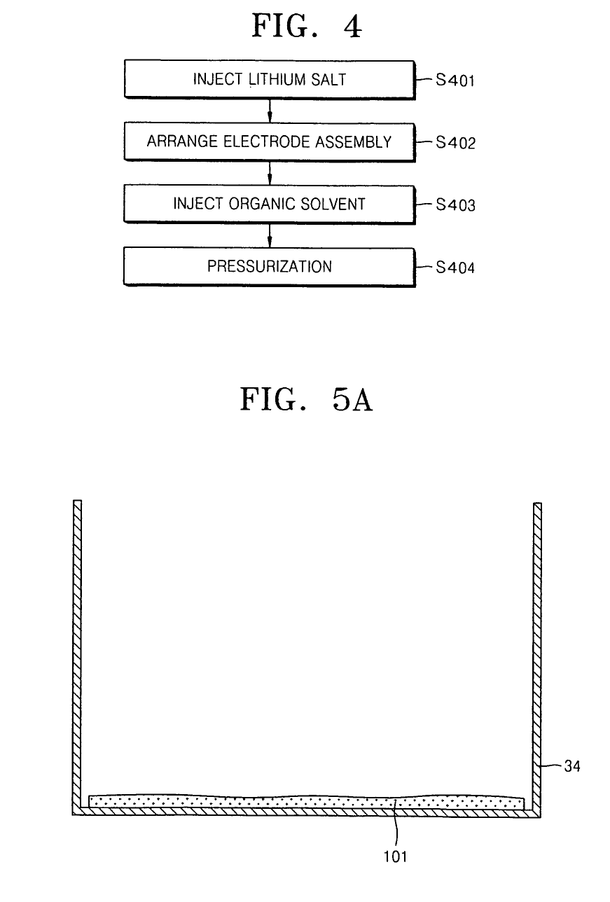

Hereinafter, by referring to FIGS. 4, 6, 7, and 8, a method of impregnating the separator 13 by separating the lithium salt 101 and the organic solvent 102 will be described.

By referring to FIGS. 4, 5A, 5B, 5C, and 5D, a method of impregnating the separator 13 by separating the lithium salt 101 and the organic solvent 102 so as to increase the impregnation process speed will now be described.

FIG. 4 is a flowchart of a method of manufacturing the secondary battery 1 (a lithium secondary battery) in accordance with an embodiment of the present invention. FIG. 5A is a cross-sectional view for describing a stage in which the lithium salt 101 is injected, in accordance with the method of FIG. 4. FIG. 5B is a cross-sectional view for describing a stage in which the electrode assembly 10 and other elements are arranged, in accordance with the method of FIG. 4. FIG. 5C is a cross-sectional view for describing a stage in which the organic solvent 102 excluding the lithium salt 101 is injected, in accordance with the method of FIG. 4. FIG. 5D is a cross-sectional view for describing a stage in which the case 34 is pressurized, in accordance with the method of FIG. 4.

Referring to FIG. 4, an impregnation process may proceed in an order of operations of injecting the lithium salt 101 (operation S401), arranging the electrode assembly 10 that includes the positive electrode 11, the separator 13, and the negative electrode 12 (operation S402), and injecting the organic solvent 102 excluding the lithium salt 101 (operation S403). The aforementioned operations of FIG. 4 will now be described with reference to related drawings.

Referring to FIG. 5A, the lithium salt 101 may be injected into the case 34 before other elements are arranged (operation S401). Here, the lithium salt 101 may be in either a solid state or in a liquid state. Also, a ratio of the lithium salt 101 may be adjusted to have a molar concentration in the range of about 0.8 mol/L to about 1.7 mol/L when the lithium salt 101 is mixed with the organic solvent 102 to be injected at a later time.

Referring to FIG. 5B, elements configuring the secondary battery 1 may be arranged in the case 34 in which the lithium salt 101 has been injected (operation S402). Even though not illustrated in the method of FIG. 4, in order to ease impregnation of the electrolyte solution 103 or the organic solvent 102, an inside of the case 34 may be vacuumed. For example, in FIG. 5B, the inside of the case 34 may form a vacuum of about 0.1 Torr, but a level of the vacuum is not limited thereto. Thus, the level of the vacuum inside the case 34 may vary.

Referring to FIG. 5C, the organic solvent 102 excluding the lithium salt 101 may be injected into the case 34 via the electrolyte solution injection hole 38a (operation S403). In order to increase an impregnation speed in a non-impregnated area A, as illustrated in FIG. 5D, the case 34 may be pressurized (operation S404). Here, after injecting the organic solvent 102, a vacuuming operation may further be performed so as to increase the impregnation speed. In this regard, after injecting the organic solvent 102, the impregnation speed may be increased by repeatedly performing the vacuuming operation and the pressuring operation (operation S404).

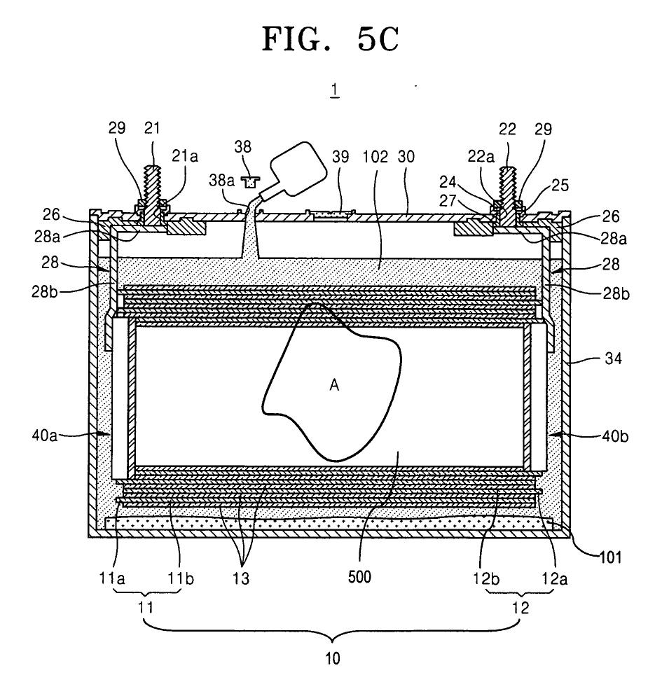

An order of the aforementioned operations is not limited to the flowchart of FIG. 4, and thus may vary. For example, FIG. 6 is a flowchart of a method of manufacturing the secondary battery 1 in accordance with another embodiment of the present invention. Referring to FIG. 6, the electrode assembly 10 may be arranged in the case 34 so that other elements of the secondary battery 1 other than the electrolyte solution 103 may be arranged (operation S601). After that, the lithium salt 101 may be injected via the electrolyte solution injection hole 38a (operation S602). The lithium salt 101 may be in a solid state and have small particles so that the lithium salt 101 may be easily dissolved in the organic solvent 102 and may be recharged via the electrolyte solution injection hole 38a. Here, before and after injecting the lithium salt 101 (operation S602), the inside of the case 34 may be vacuumed. After that, the organic solvent 102 may be injected (operation S603). In order to increase an impregnation speed, a pressurizing operation (operation S604) and a vacuuming operation may be repeated.

In accordance with the method of manufacturing the lithium secondary battery in accordance with one of the embodiments of FIGS. 4 and 6, since the lithium salt 101 first exists in the case 34, as soon as the organic solvent 102 excluding the lithium salt 101 is impregnated into the separator 13, the organic solvent 102 dissolves the lithium salt 101 so that the electrolyte solution 103 may be formed. Thus, the impregnation speed may be relatively slower than an impregnation speed of a case in which only the organic solvent 102 is impregnated into the separator 13.

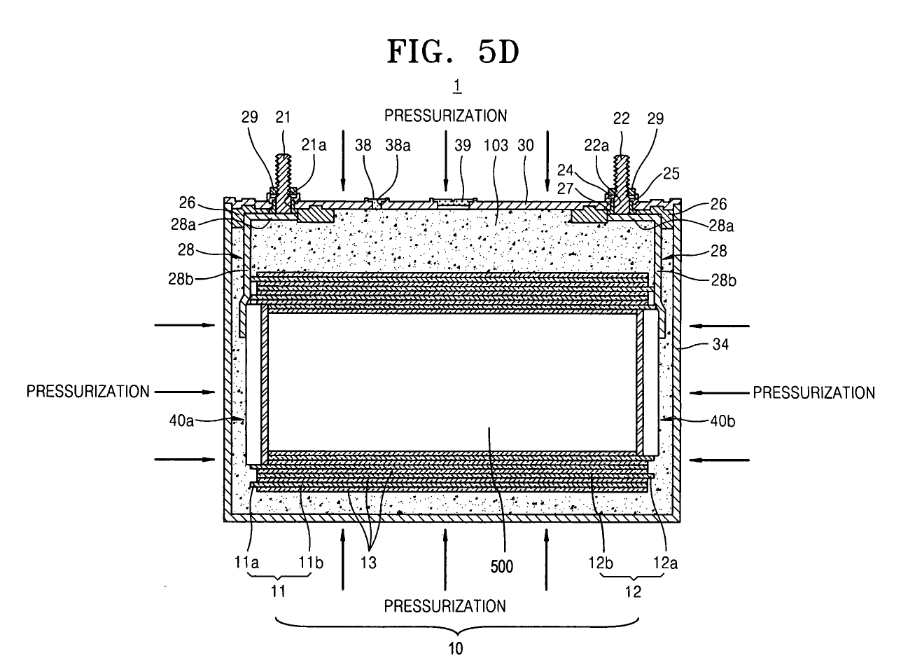

In FIG. 7, the electrode assembly 10 may be arranged in the case 34 (operation S701), and the organic solvent 102 excluding the lithium salt 101 may be injected into the case 34 (operation S702). After the injection of the organic solvent 102, the lithium salt 101 may be injected (operation S703). Here, a time interval may exist between the injection of the organic solvent 102 (operation S702) and the injection of the lithium salt 101 (operation 5703) so that the organic solvent 102 may be impregnated into the separator 13 during the time interval. After that, a pressurizing operation (operation S704) and a vacuuming operation may be repeatedly performed.

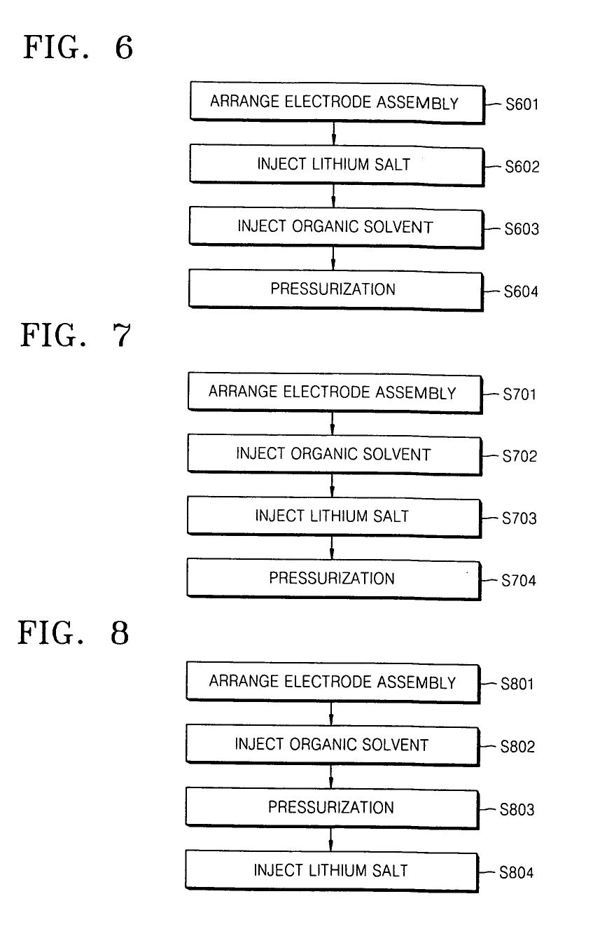

In order to reduce a lowering of the impregnation speed due to the organic solvent 102 dissolving the lithium salt 101 when the organic solvent 102 is impregnated into the separator 13, only the organic solvent 102 excluding the lithium salt 101 is impregnated into the separator 13, and then, when impregnation proceeds to a predetermined level, the lithium salt 101 may be injected. This is described with reference to FIG. 8. FIG. 8 is a flowchart of a method of manufacturing the secondary battery 1 according to another embodiment of the present invention. The electrode assembly 10 may be arranged in the case 34 so that other elements of the secondary battery 1 other than the electrolyte solution 103 may be arranged (operation S801). The organic solvent 102 may be injected into the case 34 (operation S802). Here, without injecting the lithium salt 101, the case 34 may be sealed and then a pressurizing operation (operation S803) and a vacuuming operation may be repeatedly performed. Here, since the case 34 does not have the lithium salt 101, the likelihood that the organic solvent 102 dissolves the lithium salt 101 resulting in the formation of the electrolyte solution 103 and then the impregnation speed with respect to the separator 13 is lowered may be reduced. After that, when the organic solvent 102 is impregnated into the separator 13, the lithium salt 101 may be injected via the electrolyte solution injection hole 38a. Here, since the lithium salt 101 is easily dissolved into the organic solvent 102, the lithium salt 101 may be dissolved into the organic solvent 102 so that the electrolyte solution 103 may be obtained.

Even though not illustrated in the drawings, a method of charging the lithium salt 101 in the case 34 may vary. For example, in the case where a center pin (500 is disposed in the electrode assembly 10, the lithium salt 101 may be injected into an empty space inside the center pin disposed in the electrode assembly 10. The lithium salt 101 may be injected and disposed anywhere inside the case 34.

It should be understood that the exemplary embodiments described herein should be considered in a descriptive sense only and not for purposes of limitation. Descriptions of features or aspects within each embodiment should typically be considered as available for other similar features or aspects in other embodiments.

What is claimed is:

1. A method of manufacturing a lithium secondary battery, the method comprising:
injecting a lithium salt;
arranging an electrode assembly comprising a positive electrode, a separator, and a negative electrode; and
injecting a solvent excluding the lithium salt.

2. The method of claim 1, wherein the method is performed in an order of:
arranging the electrode assembly;
injecting the lithium salt; and
injecting the solvent excluding the lithium salt.

3. The method of claim 1, wherein the method is performed in an order of:
arranging the electrode assembly;
injecting the solvent excluding the lithium salt; and
injecting the lithium salt.

4. The method of claim 1, further comprising:
performing a vacuuming operation; and
performing a pressurizing operation.

5. The method of claim 4, wherein the method is performed in an order of:
arranging the electrode assembly;
injecting the solvent excluding the lithium salt;
performing the vacuuming operation;
performing the pressurizing operation; and
injecting the lithium salt.

6. The method of claim 1, wherein the lithium salt is in a solid state.

7. The method of claim 1, wherein the lithium salt is in a liquid state.

8. The method of claim 1, wherein the lithium salt has a molar concentration in a range of about 0.8 mol/L to about 1.7 mol/L when the lithium salt is mixed with the solvent.

9. The method of claim 1, wherein the lithium salt is at least one selected from the group consisting of LiPF₆, LiBF₄, LiClO₄, Li(CF₃SO₂)₂, LiCF₃SO₃, LiSbF₆ and LiAsF₆.

10. The method of claim 1, wherein the solvent is a mixture of cyclic carbonate selected from the group consisting of polyethylene carbonate, ethylene carbonate, and propylene carbonate, and chain carbonate selected from the group consisting of dimethyl carbonate and diethyl carbonate.

11. The method of claim 1, wherein the electrode assembly is wound and has a center pin in a center therein, and the injecting the lithium salt comprises charging the lithium salt in the center pin.

12. A method of manufacturing a lithium secondary battery, the method comprising steps of:
performing an arrangement of an electrode assembly comprising a positive electrode, a separator, and a negative electrode; and
separately performing an injection of a lithium salt into the lithium secondary battery and an injection of a solvent excluding the lithium salt into the lithium secondary battery.

13. The method of claim 12, wherein the injection of the lithium salt is performed prior to the injection of the solvent excluding the lithium salt.

14. The method of claim 12, wherein the injection of the solvent excluding the lithium salt is performed prior to the injection of the lithium salt.

15. The method of claim 12, further comprising steps of:
performing a vacuuming operation within a case of the lithium secondary battery; and
performing a pressurizing operation on an outer surface of the case of the lithium secondary battery.

16. The method of claim 15, wherein the pressurizing operation is performed between the injection of the solvent excluding the lithium salt and the injection of the lithium salt.

17. The method of claim 15, wherein the pressurizing operation is performed after the injection of the solvent excluding the lithium salt and the injection of the lithium salt.

18. The method of claim 12, wherein the lithium salt is in a solid state.

19. The method of claim 12, wherein the lithium salt is in a liquid state.

20. The method of claim 12, wherein the lithium salt is at least one selected from the group consisting of LiPF₆, LiBF₄, LiClO₄, Li(CF₃SO₂)₂, LiCF₃SO₃, LiSbF₆ and LiAsF₆; and
wherein the solvent is a mixture of cyclic carbonate selected from the group consisting of polyethylene carbonate, ethylene carbonate, and propylene carbonate, and chain carbonate selected from the group consisting of dimethyl carbonate and diethyl carbonate.
